(19) United States
(12) Patent Application Publication
(10) Pub. No.: US 2015/0112574 A1
(43) Pub. Date: Apr. 23, 2015

(54) Method of Controlling Banks in Vehicle Using CDA

(71) Applicant: Hyundai Motor Company, Seoul (KR)

(72) Inventor: Bon Chang KOO, Whasung-Si (KR)

(73) Assignee: Hyundai Motor Company, Seoul (KR)

(21) Appl. No.: 14/104,460

(22) Filed: Dec. 12, 2013

(30) Foreign Application Priority Data
Oct. 21, 2013 (KR) 10-2013-0125147

(51) Int. Cl. F02D 17/02

(52) U.S. Cl. CPC F02D 17/02
USPC 701/103

(57) ABSTRACT

A method of controlling banks in a vehicle using cylinder deactivation (CDA) may include determining whether the CDA of an engine of the vehicle is turned on or off, determining whether a temperature of a catalyst is below a predetermined temperature if it is determined that the CDA is turned on, switching from a second bank including first, third and fifth cylinders to a first bank including second, fourth and sixth cylinders or from the first bank to the second bank if it is determined that the temperature of the catalyst is below the predetermined temperature, so that the first and second banks maintain the temperature of the catalyst above the predetermined temperature.

### CROSS-REFERENCE TO RELATED APPLICATION

The present application claims priority of Korean Patent Application Number 10-2013-0125147 filed Oct. 21, 2013, the entire contents of which application are incorporated herein for all purposes by this reference.

### BACKGROUND OF INVENTION

1. Field of Invention

The present invention relates to a method of controlling banks in a vehicle using cylinder deactivation (CDA), and more particularly, to a method of controlling banks in a vehicle using CDA that increases catalyst purification efficiency by way of allowing banks to maintain the temperature of a catalyst above a predetermined temperature.

2. Description of Related Art

A cylinder deactivation (CDA) engine deactivates some of the cylinders when a vehicle is stopped or is traveling at a constant speed. In a deactivated cylinder, fuel supply is stopped and intake valves and exhaust values are interrupted.

CDA engines are developed for high fuel economy cars to meet global issues such as a rise in oil price and environmental problems caused by vehicle exhaust emissions.

In vehicles with CDA engines, it is important to increase fuel efficiency by minimizing a backup power while hardly harming operability and stability. Further, it is also important to ensure that a catalyst in a deactivated cylinder normally gets back to work when the cylinder is back in operation.

In an existing CDA engine, air flows toward a catalyst so that the catalyst is chilled, and if a driver accelerates at this time, CDA turns off so that emissions are made instantaneously. Accordingly, the catalyst is cooled down and thus purification efficiency becomes abnormal.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to solve at least some of the above-mentioned problems occurring in the prior art while advantages achieved by the prior art are maintained intact. Various aspects of the present invention provide for a method of controlling banks in a vehicle using CDA, and more particularly, a method of controlling banks in a vehicle using CDA that increases a catalyst purification efficiency by way of allowing banks to maintain the temperature of a catalyst above a predetermined temperature.

In various aspects of the present invention, there is provided a method of controlling banks in a vehicle using cylinder deactivation (CDA), the method including: determining whether the CDA of an engine of the vehicle is turned on or off; determining whether a temperature of a catalyst is below a predetermined temperature if it is determined that the CDA is turned on; switching from a second bank including first, third and fifth cylinders to a first bank including second, fourth and sixth cylinders or from the first bank to the second bank if it is determined that the temperature of the catalyst is below the predetermined temperature, so that the first and second banks maintain the temperature of the catalyst above the predetermined temperature.

In the determining whether the temperature of the catalyst is below the predetermined temperature, the predetermined temperature may be set to be about 300° C. Further, the switching may have a transient interval to allow to switch from the second bank to the first bank or from the first bank to the second bank.

In the switching from the second bank to the first bank, an injector and a spark plug may be interrupted in the first cylinder, an injector and a spark plug may be operated in the second cylinder, after a predetermined delay, an injector and a spark plug may be operated in the third cylinder and the spark compensation may be interrupted in the second cylinder, an injector and a spark plug may be operated in the fourth cylinder, an injector and a spark plug may be interrupted in the fifth cylinder, and an injector and a spark plug may be operated in the sixth cylinder.

In the switching from the second bank to the first bank, an injector and a spark plug may be interrupted in the second cylinder, an injector and a spark plug may be operated in the third cylinder, after a predetermined delay, an injector and a spark plug may be operated in the fourth cylinder and the spark compensation may be interrupted in the third cylinder, an injector and a spark plug may be operated in the fifth cylinder, an injector and a spark plug may be interrupted in the sixth cylinder, and an injector and a spark plug may be operated in the first cylinder.

If it is determined that the CDA is turned off, an injector and a spark plug may be operated in the first cylinder, after a first predetermined delay, an injector and a spark plug may be operated in the third cylinder, and after a second predetermined delay, an injector and a spark plug may be operated in the fifth cylinder, so that a change in engine power may be decreased.

If it is determined that the CDA is turned off, an injector and a spark plug may be operated in the second cylinder, after a first predetermined delay, an injector and a spark plug may be operated in the fourth cylinder, and after a second predetermined delay, an injector and a spark plug may be operated in the sixth cylinder, so that a change in engine power may be decreased.

The predetermined delay, the first predetermined delay and/or the second predetermined delay may be set to be about one second.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating an exemplary method of controlling banks in a vehicle using CDA according to the present invention;

FIGS. 2 and 3 are flowcharts illustrating switching between banks in an exemplary method of controlling banks in a vehicle using CDA according to the present invention; and

FIGS. 4 and 5 are flowcharts illustrating turning off CDA in an exemplary method of controlling banks in a vehicle using CDA according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

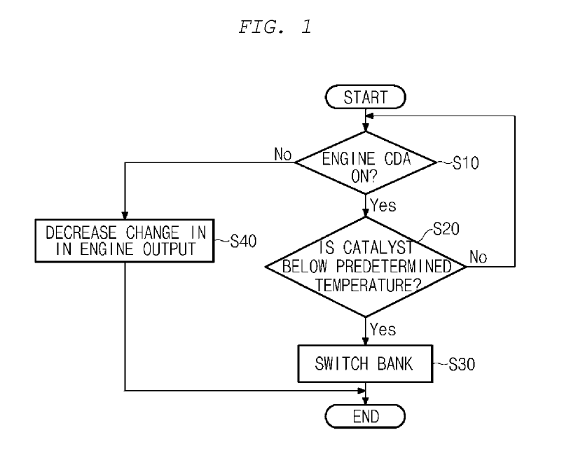

A method of controlling banks in a vehicle using CDA, according to various exemplary embodiments f the present invention, may include, as illustrated in FIGS. 1 to 5, determining whether CDA is turned on or off in an engine of a vehicle (S10), if it is determined that CDA is turned on, determining whether the temperature of a catalyst is below a predetermined temperature (S20), and if it is determined that the temperature of the catalyst is below the predetermined temperature, switching from a second bank to a first bank or vice versa (S30).

As shown in FIG. 1, the determining S10 determines whether cylinder deactivation (CDA) in an engine of a vehicle is turned on or off and, if it is determined that CDA is turned on, proceeds to the determining S20. In this regard, the CDA is known and, therefore, a detailed description thereon will not be made.

If it is determined that the CDA is turned on in the determining S10, the determining S20 determines whether the temperature of a catalyst is below a predetermined temperature and, if it is determined that the temperature of the catalyst is below the predetermined temperature, it proceeds to the switching S20. If it is determined that the temperature of the catalyst is not below the predetermined temperature, which means no cool down has occurred, the determining S20 returns back to the previous operation. Preferably, the predetermined temperature of the catalyst is set to be about 300° C. in determining (S20) whether to proceed to the switching (S30). However, one would appreciate that the predetermined temperature is not limited to 300° C. but rather readily adjustable.

In the switching (S30), if the temperature of the catalyst is below the predetermined temperature, e.g., 300° C., in the determining (S20), the second bank including first, third and fifth cylinders is switched with the first bank including second, fourth and sixth cylinders or vice versa, so that the first and second banks may maintain the temperature of the catalyst equal to or higher than the predetermined temperature.

Further, the switching (S30) may include a transient region so that switching from the second banks to the first bank and vice versa is possible.

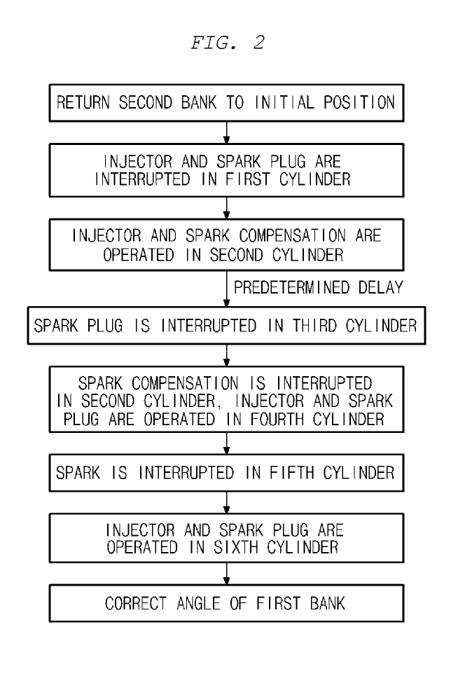

During the switching from the second bank to the first bank (S30), as shown in FIG. 2, an injector and a spark plug are interrupted in a first cylinder, an injector and a spark plug are operated in a second cylinder, after a predetermined delay, an injector and a spark plug are operated in a third cylinder and the spark plug is interrupted in the second cylinder, an injector and a spark plug are operated in a fourth cylinder, an injector and a spark plug are interrupted in a fifth cylinder, and an injector and a spark plug are operated in a sixth cylinder, so that switching from the second bank to the first bank is performed by angle correction.

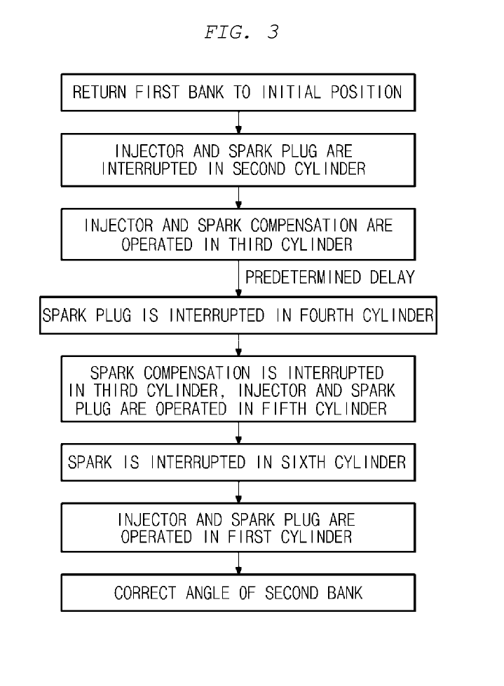

In addition, during the switching from the first bank to the second bank (S30), as shown in FIG. 3, the injector and the spark plug are interrupted in the second cylinder, the injector and a spark plug are operated in the third cylinder, after a predetermined delay, the injector and the spark plug are operated in the fourth cylinder and the spark plug is interrupted in the third cylinder, the injector and the spark plug are operated in the fifth cylinder, the injector and the spark plug are interrupted in the sixth cylinder, and the injector and the spark plug are operated in the first cylinder, so that switching from the first bank to the second bank is performed by angle correction. Preferably, the predetermined delay is about 1 second. However, one would appreciate that the predetermined delay is not limited to 1 second but rather readily adjustable.

As such, according to the present invention, switching from the second bank to the first bank or vice versa is possible even if cooling down happens, so that the temperature of the catalyst may be maintained above a predetermined temperature.

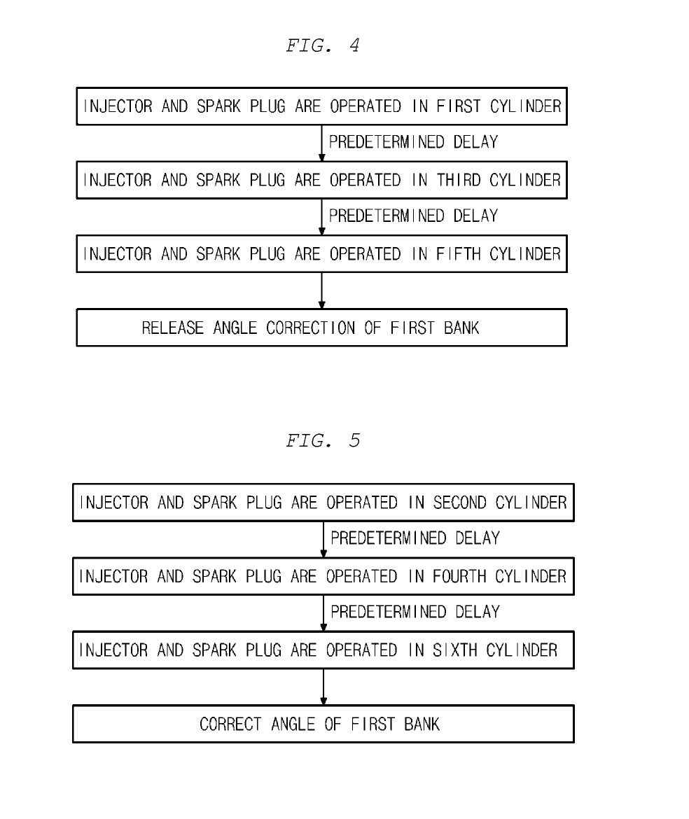

On the other hand, if it is determined in S10 that CDA is turned off, as shown in FIG. 4, through the second bank, the injector and spark plug may be operated in the first cylinder, after a predetermined delay, the injector and spark plug are operated in the third cylinder, and after a predetermined delay, the injector and spark plug are operated in the fifth cylinder, so that the angle correction for the first bank is released, thereby decreasing a change in the engine power.

Further, if it is determined in S10 that the CDA is turned off, as shown in FIG. 5, even through the first bank, the injector and spark plug may be operated in the second cylinder, after a predetermined delay, the injector and spark plug are operated in the fourth cylinder, and after a predetermined delay, the injector and spark plug are operated in the sixth cylinder, so that the angle of the first bank is corrected, thereby decreasing a change in the engine power (S40). In this case, the predetermined delay is about 1 second, or other suitable values as desired.

As such, according to the present invention, a change in the engine power is decreased through the first bank or the second bank even if CDA is turned off, so that the operability can be improved.

As set forth above, according to various exemplary embodiments of the preset invention, each of the banks may maintain the temperature of a catalyst above a predetermined temperature by preventing the catalyst from being cooled down. Further, fuel supply and ignition timing are individually controlled in cylinders of an engine, such that a change in the engine power is minimized. Accordingly, marketability and operability can be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling banks in a vehicle using cylinder deactivation (CDA), the method comprising:
determining whether the CDA of an engine of the vehicle is turned on or off;
determining whether a temperature of a catalyst is below a predetermined temperature if it is determined that the CDA is turned on; and
switching from a second bank including first, third and fifth cylinders to a first bank including second, fourth and sixth cylinders or from the first bank to the second bank if it is determined that the temperature of the catalyst is below the predetermined temperature, so that the first and second banks maintain the temperature of the catalyst above the predetermined temperature.

2. The method according to claim 1, wherein in the determining whether the temperature of the catalyst is below the predetermined temperature, the predetermined temperature is set to be about 300° C.

3. The method according to claim 1, wherein the switching has a transient interval to allow to switch from the second bank to the first bank or from the first bank to the second bank.

4. The method according to claim 1, wherein in the switching from the second bank to the first bank:
an injector and a spark plug are interrupted in the first cylinder, an injector and a spark plug are operated in the second cylinder;
after a predetermined delay, an injector and a spark plug are operated in the third cylinder and the spark compensation is interrupted in the second cylinder, an injector and a spark plug are operated in the fourth cylinder; and
an injector and a spark plug are interrupted in the fifth cylinder, and an injector and a spark plug are operated in the sixth cylinder.

5. The method according to claim 1, wherein in the switching from the first bank to the second bank:
an injector and a spark plug are interrupted in the second cylinder, an injector and a spark plug are operated in the third cylinder;
after a predetermined delay, an injector and a spark plug are operated in the fourth cylinder and the spark compensation is interrupted in the third cylinder, an injector and a spark plug are operated in the fifth cylinder;
an injector and a spark plug are interrupted in the sixth cylinder, and an injector and a spark plug are operated in the first cylinder.

6. The method according to claim 1, wherein if it is determined that the CDA is turned off, an injector and a spark plug is operated in the first cylinder, after a first predetermined delay, an injector and a spark plug is operated in the third cylinder, and after a second predetermined delay, an injector and a spark plug is operated in the fifth cylinder, so that a change in engine power is decreased.

7. The method according to claim 1, wherein if it is determined that the CDA is turned off, an injector and a spark plug is operated in the second cylinder, after a first predetermined delay, an injector and a spark plug is operated in the fourth cylinder, and after a second predetermined delay, an injector and a spark plug is operated in the six cylinder, so that a change in engine power is decreased.

8. The method according to claim 4, wherein the predetermined delay is set to be about one second.

9. The method according to claim 5, wherein the predetermined delay is set to be about one second.

10. The method according to claim 6, wherein the first predetermined delay and/or the second predetermined delay are set to be about one second.

11. The method according to claim 7, wherein the first predetermined delay and/or the second predetermined delay are set to be about one second.
